(19) United States
(12) Patent Application Publication
(10) Pub. No.: US 2010/0155990 A1
(43) Pub. Date: Jun. 24, 2010

(54) METHOD FOR MANUFACTURING KEYPAD OF PORTABLE TERMINAL

(75) Inventors: Yoon Hong Yang, Seoul (KR); Ji Young Hyun, Gyeonggi-do (KR)

Correspondence Address: WRB-IP LLP, 1217 KING STREET, ALEXANDRIA, VA, 22314, US

(73) Assignee: DK UIL CO., LTD., Gyeonggi-do (KR)

(21) Appl. No.: 11/993,052

(22) PCT Filed: May 23, 2006
(86) PCT No.: PCT/KR06/01925

§ 371 Date: Dec. 19, 2007

(30) Foreign Application Priority Data
Jun. 21, 2005 (KR) 10-2005-0053708

(51) Int. Cl. B29C 45/14

(52) U.S. Cl. 264/259

(57) ABSTRACT

Disclosed is a method for manufacturing a keypad of a portable terminal, in which a metal thin layer (62) deposited on a base film (61) is easily and finely patterned to form fonts (62a) having a three-dimensional pattern, and key top-shaped grooves (61a) are formed in a metal laminate thin film (60) and filled with injecting molded matter (70).

### TECHNICAL FIELD

The present invention relates to a method for manufacturing a keypad of a portable terminal, and more particularly to a method for manufacturing a keypad of a portable terminal, in which a metal thin layer deposited on a base film is finely patterned to form fonts, and key top-shaped grooves are formed in a metal laminate thin film and filled with injecting molded matter.

### BACKGROUND ART

In general, a keypad is applied to portable terminals including telephone sets for home use, PDAs, and cellular phones, and serves as a switching member, which is operated together with a circuit board to generate signals.

Hereinafter, for the convenience, a keypad, which is applied to a cellular phone, will be described. However, the application of the keypad of the present invention is not limited thereto.

FIG. 1 is a perspective view of a cellular phone, to which a conventional keypad is applied, and FIG. 2 is a sectional view of the conventional keypad, which is mounted on dome switches (D) and a circuit board (H).

As shown in FIGS. 1 and 2, the conventional keypad 50 is provided in a front housing (F) containing lamps (L) serving as light sources for supplying light, and comprises a pad 20 mounted on the dome switches (D) and keys 10, such as dial keys and function keys, each of which has a key top 11 and a font 11a, such as a symbol, a character, or a number, formed on the key top 11.

The pad 20 comprises protrusions 21, which are elastically operated together with the dome switches (D) and touch contact points (H1) of the circuit board. Each of the keys 10 is completed by forming the font 11a on the key top 11 by printing, spraying, or laser machining.

FIG. 3 is a view illustrating a method for manufacturing the conventional keypad.

As shown in FIG. 3, the method for manufacturing the conventional keypad 50 comprises forming the key tops 11 by injecting a plastic solution into key-shaped grooves 31 in a lower mold 30, pressing the lower mold 30 having the plastic solution in the key-shaped grooves 31 with an upper mold 40, and hardening the plastic solution (S1), forming keys 10 by coating the upper surfaces of the key tops 11 with a spray and laser-marking the upper surfaces of the key tops 11 (S2), and attaching the keys 10 to the pad 20 having the protrusions 21.

Since the keys 10, which are exposed from the front housing (F), are functional structures only for forming the fonts 11a thereon, the conventional keypad 50 does not satisfy requirements of customers, which want aesthetic and luxurious portable terminals.

Further, since the method for manufacturing the conventional keypad comprises forming the key tops 11, each having a simple and basic shape, by injecting liquid silicon rubber into the key-shaped grooves 31 of the lower mold 30 and pressing the lower mold having the liquid silicon rubber into the key-shaped grooves 31 with the upper mold 40, it is difficult to express various textures and three-dimensional patterns, particularly to express a hologram pattern or a hairline pattern on the surfaces of the key tops 11.

### DISCLOSURE OF INVENTION

### Technical Problem

Therefore, the present invention has been made in view of the above problems, and it is an object of the present invention to provide a method for manufacturing a keypad of a portable terminal, in which a metal thin layer deposited on a base film is finely patterned to form fonts, and key top-shaped grooves are formed in a metal laminate thin film and filled with injecting molded matter, thereby allowing the keypad to exhibit a luxurious texture and to be effectively manufactured.

Technical Solution

In accordance with an aspect of the present invention, the above and other objects can be accomplished by the provision of a method for manufacturing a keypad of a portable terminal, having keys and a pad, comprising preparing a metal laminate thin film obtained by coating a base film with a metal thin layer; patterning the metal thin layer, to form fonts; locating the metal laminate thin film on a lower mold having key top-shaped grooves formed therein and pressing the metal laminate thin film by a first upper mold having key top-shaped protrusions formed thereon, to form key top-shaped grooves in the metal laminate thin film; and filling the key top-shaped grooves with injecting molded matter made of synthetic resin and pressing the matter by a second upper mold, to form an integrated key assembly having the keys, each provided with a key top-shaped injecting molded matter.

### ADVANTAGEOUS EFFECTS

In the method of the present invention, the metal thin layer deposited on the base film is easily and finely patterned to form the fonts having a three-dimensional pattern, and the key top-shaped grooves are formed in the metal laminate thin film and filled with injecting molded matter, thereby effectively producing a luxurious and aesthetic keypad.

Further, a metal plating layer and a protective coating layer are further formed on the metal laminate thin film, thereby allowing lamps to emit brilliant light. Moreover, a printing plane causes the light to have various colors.

### BRIEF DESCRIPTION OF THE DRAWINGS

The above and other objects, features and other advantages of the present invention will be more clearly understood from the following detailed description taken in conjunction with the accompanying drawings, in which:

FIG. 4 is a sectional view of a keypad of a portable terminal, which is mounted on dome switches and a circuit board, in accordance with a first embodiment of the present invention;

FIG. 5 is a sectional view of a keypad of a portable terminal, which is mounted on dome switches and a circuit board, in accordance with a second embodiment of the present invention; and

FIGS. 6 to 8 are views illustrating a method for manufacturing a keypad of a portable terminal in accordance with the present invention.

### BEST MODE FOR CARRYING OUT THE INVENTION

Now, preferred embodiments of the present invention will be described in detail with reference to the annexed drawings.

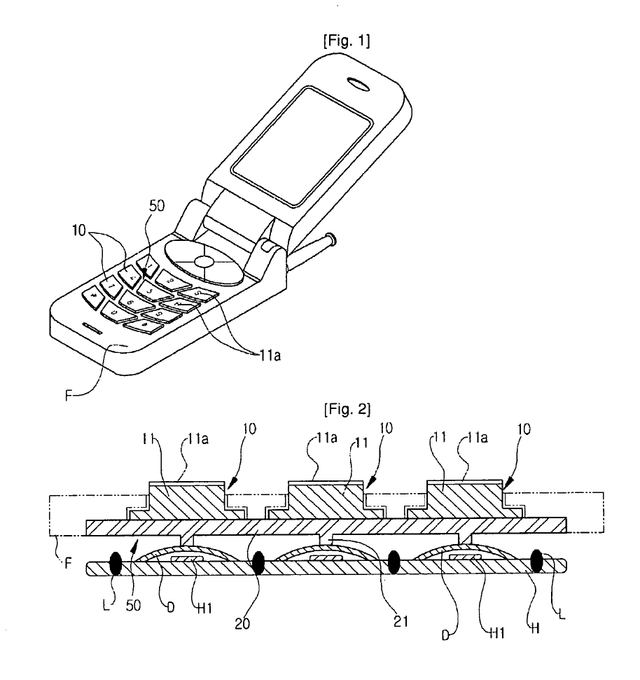

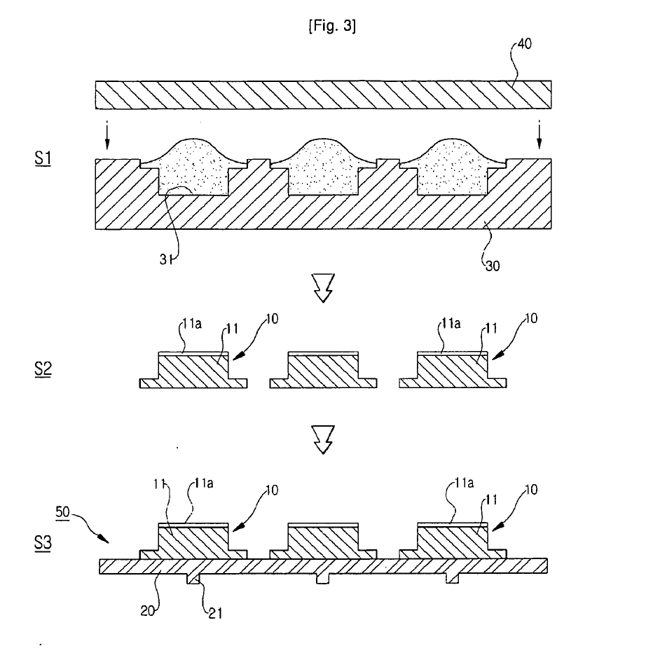

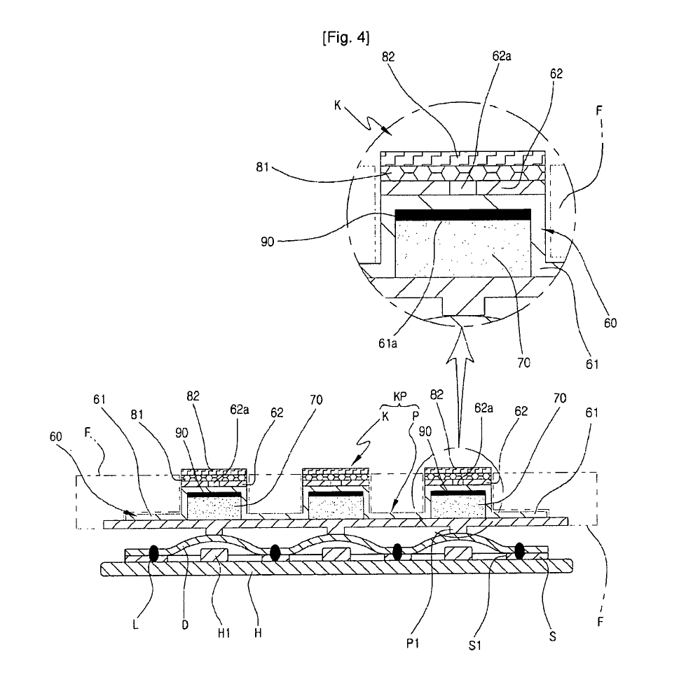

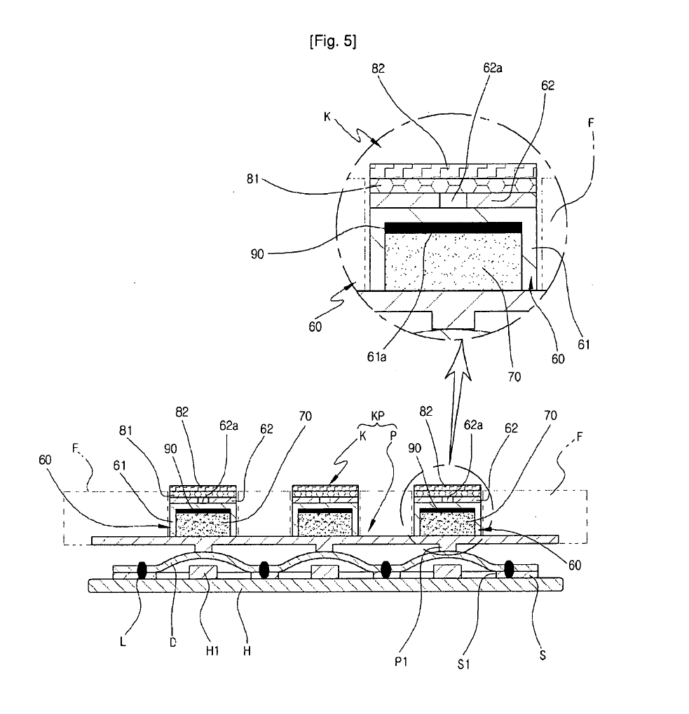

FIG. 4 is a sectional view of a keypad of a portable terminal, which is mounted on dome switches (D) and a circuit board (H), in accordance with a first embodiment of the present invention, and FIG. 5 is a sectional view of a keypad of a portable terminal, which is mounted on dome switches (D) and a circuit board (H), in accordance with a second embodiment of the present invention.

The keypad of the present invention is provided in a front housing (F) containing lamps (L) serving as light sources for supplying light, and comprises a pad (P) mounted on the dome switches (D) and keys (K), such as dial keys and function keys.

The pad (P) comprises protrusions (P), which are elastically operated together with the dome switches (D) and touch contact points (H1) of the circuit board (H). Spacers (S), each having a hole (H1), are located between the dome switches (D) and the circuit board (H).

More specifically, the present invention relates to the keys (K) of the keypad of the portable terminal. As shown in FIGS. 4 and 5, the keys (K) may be integrated into a single body, or be separated from each other. The keys (K) comprise a base film 61 having key top-shaped grooves 61a, a metal thin layer 62 coating the base film 61 for forming fonts 62a, and injecting molded matter 70 filling the key top-shaped grooves 61a for forming key tops.

A polyimide film or a polyester film is used as the base film 61, and a Cu thin layer, which is deposited on the base film 61, is used as the metal thin layer 62. In case that the polyimide film is used as the base film 61 and the Cu thin film is used as the metal thin layer 62, as described above, a Copper Clad Laminate (CCL) film, which is applied to a Flexible Printed Circuit Board (FPCB), is used. However, the base film 61 and the metal thin layer 62 are not limited thereto, but may be made of other materials.

The Cu thin layer of the CCL film allows fine and brilliant fonts 62a to be formed therein by a patterning process using a photosensitive film. That is, the metal thin layer 62 is coated with a photosensitive resin or a photosensitive film, and is selectively removed by exposing, developing, etching, and stripping steps. The fonts 62a formed in the metal thin layer 62 may have various three-dimensional patterns, i.e., a hairline pattern and a hologram pattern.

A metal plate layer 81 is formed on the metal thin layer 62 having the fonts 62a. If necessary, a protective coating layer 82 may be additionally formed on the metal plating layer 81, and a printing plane 90 may be interposed between the base film 61 and the injecting molded matter 70.

The metal plating layer 81 is formed on the metal thin layer 62 by deposition using sputtering or electroplating using semiconductor, such as TiN, SiO₂, or CrO₂, or metal, such as gold, chrome, silver, tin, or aluminum.

The metal plating layer 81 facilitates the expression of the luxurious texture of the keypad, and provides a rainbow hologram effect due to diffraction, refraction, and dispersion of light from the lamps (L) transmitted by the fonts 62a around metal plating layer 81.

The protective coating layer 82 is formed by UV-coating, and serves to prevent the metal plating layer 81 from being worn away.

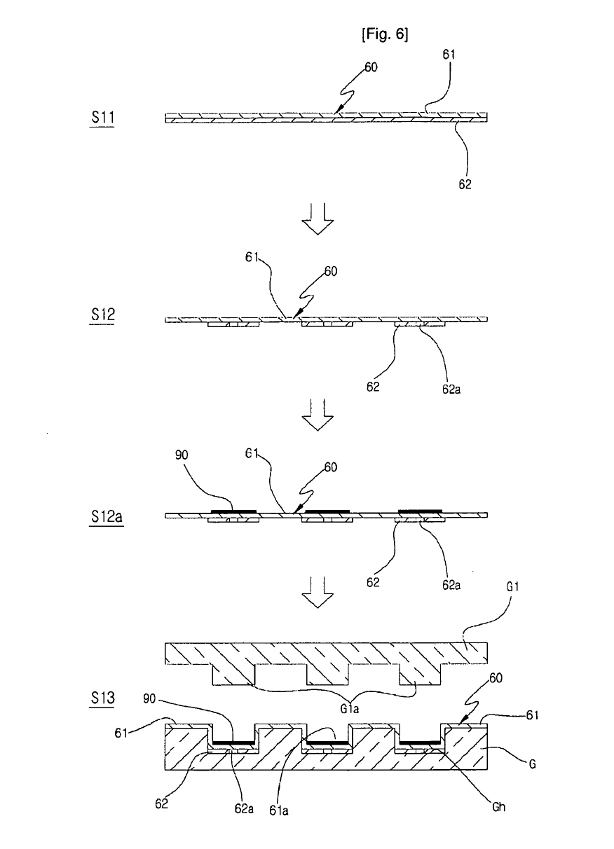

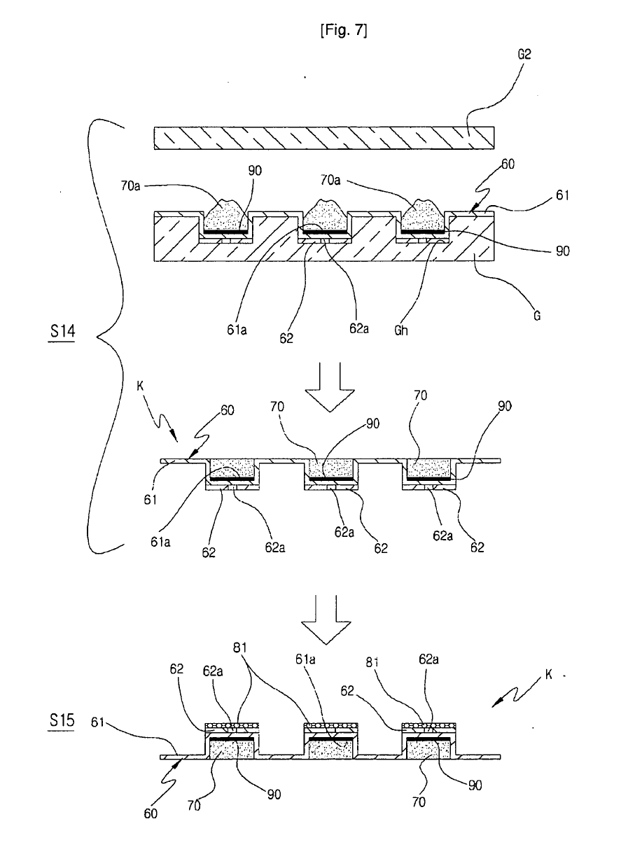

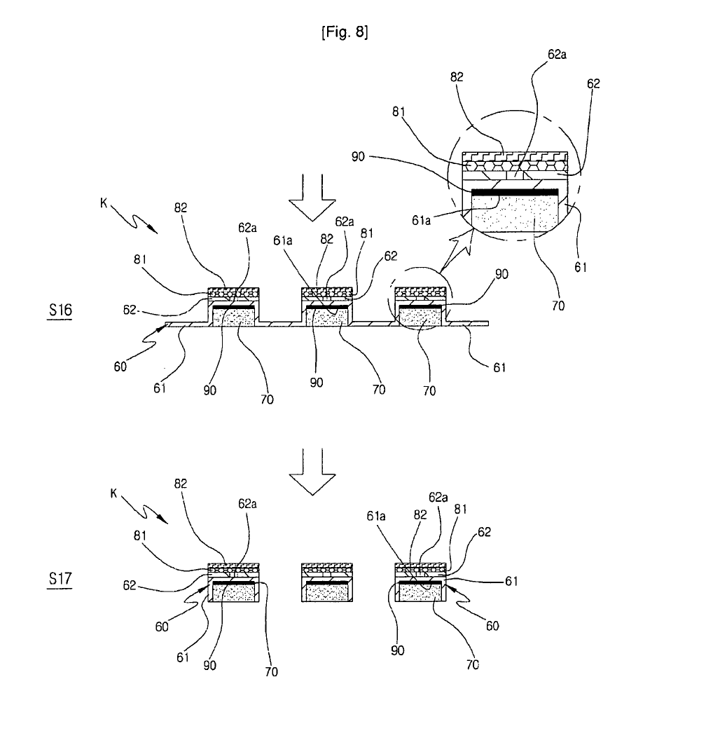

FIGS. 6 to 8 are views illustrating a method for manufacturing a keypad of a portable terminal in accordance with the present invention.

As shown in FIGS. 6 to 8, the method for manufacturing the keypad in accordance with the present invention refers to a method for manufacturing the keys (K) of the keypad (KP), which has the keys (K) and the pad (P).

More particularly, a metal laminate thin film 60, such as a CCL film, which is obtained by coating the base film 61, such as a polyimide film or a polyester film, with the metal thin layer 62, such as a Cu thin layer, is prepared (S11), and the metal thin layer 62 of the metal laminate thin film 60 is patterned to form the fonts 62a therein (S12).

The patterning process of the metal thin layer 62 is performed by coating the metal thin layer 62 with a photosensitive resin or a photosensitive film and by performing exposing, developing, etching, and stripping steps, and forms the fonts 62a having various three-dimensional patterns, such as a hairline pattern and a hologram pattern. When the CCL film is used, the patterning process is more easily performed.

The printing planes 90 having various colors are formed on the rear surface of the base film 61 having the fonts 62a obtained by patterning the metal thin layer 62, thereby expressing various colors when light from the lamps (L) is transmitted by the base film 61 (S12a).

Thereafter, the metal laminate thin film 60 is located on a lower mold (G) having key top-shaped grooves (Gh), and is pressed by a first upper mold (G1) having key top-shaped protrusions (G11), thereby obtaining the key top-shaped grooves 61a formed therein (S13). The key top-shaped grooves 61a are filled with injecting molded matter 70a made of synthetic resin and are pressed by a second upper mold (G2), thereby producing the key top-shaped injecting molded matter 70 (S14). Thereby, an integrated key assembly, as shown in FIG. 4, is prepared.

The metal plating layer 81 is formed on the metal thin layer 62 having the fonts 62a by deposition using sputtering or by electroplating, thus expressing the luxurious texture of the keypad. Preferably, the metal plating layer 81 is formed on the metal thin layer 62 by deposition using sputtering or electroplating using semiconductor, such as TiN, SiO₂, or CrO₂, or metal, such as gold, chrome, silver, tin, or aluminum, thereby providing a rainbow hologram effect due to diffraction, refraction, and dispersion of light from the lamps (L), transmitted by the fonts 62a, around metal plating layer 81 (S15).

Thereafter, the protective coating layer 82 for preventing the metal plating layer 81 from being worn away or being contaminated by user's fingerprints or foreign substances is formed on the metal plating layer 81 (S16).

Finally, the keypad (KP) is divided into individual keys (K), as shown in FIG. 5, each having the key top-shaped injecting molded matter 70 filling the corresponding key top-shaped groove 61a, by cutting (S17).

In the keypad of the portable terminal of the present invention, which has the above constitution and is manufactured by the above process, when a user selectively presses one key (K) having a designated font 62a formed thereon, the protrusions (P1) formed on the lower surface of the pad (P) contacts the contact point (H1) of the circuit board (H) against the elastic force of the dome switch (D) to generate a signal. Further, at this time, light emitted from the lamps (L) is transmitted by the printing planes 90 and changed into rays having various colors, and the rays are exposed to the outside through the fonts 62a. Here, the rays are dispersed or refracted by the three-dimensional patterns of the fonts 62a, such as the hairline pattern or the hologram pattern, thus expressing a rainbow effect and exhibiting a luxurious and three-dimensional effect.

After the signal is generated, when the user releases his/her finger from the key (K), the protrusion (P1) returns to its original position due to the elasticity of the dome switch (D).

Although LEDs mounted on the circuit board (H) are used as the lamps (L) in FIGS. 4 and 5, Electro Luminescent (EL) lamps may be used as the lamps (L).

As described above, in the method of the present invention, the metal thin layer 62 deposited on the base film 61 is easily and finely patterned to form the fonts 62a having a three-dimensional pattern, and the key top-shaped grooves 61a are formed in the metal laminate thin film 60 and filled with injecting molded matter 70.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

For example, an adhesive is applied to the key top-shaped grooves 61a and the key top-shaped grooves 61a are filled with injecting molded matter 70 using the adhesive.

### INDUSTRIAL APPLICABILITY

As apparent from the above description, the present invention provides a method for manufacturing a keypad of a portable terminal of the present invention, in which a metal thin layer deposited on a base film is finely patterned to form fonts, and key top-shaped grooves are formed in a metal laminate thin film and filled with injecting molded matter, thereby producing a high-quality keypad.

1. A method for manufacturing a keypad of a portable terminal, having keys and a pad, comprising:
preparing a metal laminate thin film obtained by coating a base film with a metal thin layer;
patterning the metal thin layer, to form fonts;
locating the metal laminate thin film on a lower mold having key top-shaped grooves formed therein and pressing the metal laminate thin film by a first upper mold having key top-shaped protrusions formed thereon, to form key top-shaped grooves in the metal laminate thin film; and
filling the key top-shaped grooves with injecting molded matter made of synthetic resin and pressing the matter by a second upper mold, to form an integrated key assembly having the keys, each provided with a key top-shaped injecting molded matter.

2. The method as set forth in claim 1, further comprising forming a metal plating layer on the metal thin layer having the fonts.

3. The method as set forth in claim 2, further comprising forming a protective coating layer on the metal plating layer.

4. The method as set forth in any one of claims 1 to 3, further comprising forming a printing plane on the base film, after the patterning of the metal thin layer.

5. The method as set forth in claim 4, further comprising dividing the integrated key assembly into the individual keys, each provided with the key top-shaped injecting molded matter filling, by cutting.
